(19) United States
(12) Patent Application Publication
(10) Pub. No.: US 2006/0256777 A1
(43) Pub. Date: Nov. 16, 2006

(54) Communication system, exchange apparatus, and communication method

(75) Inventors: Shingo Kimura, Ome-shi (JP); Kazuhiro Kobashi, Ichikawa-shi (JP); Motohisa Araki, Akishima-shi (JP); Shuichi Sato, Sagamihara-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/316,564

(22) Filed: Dec. 21, 2005

(30) Foreign Application Priority Data
May 10, 2005 (JP) 2005-137387

(51) Int. Cl. G06F 15/16; H04L 12/16; H04L 12/66

(52) U.S. Cl. 370/352; 370/260; 709/204

(57) ABSTRACT

An exchange apparatus includes an acquisition circuit to acquire transmission-source identification information included in the header areas and transmission-source ID included in the data areas of the communication packets received from each of a plurality of communication terminals to be connection objects when communication terminals are connected with one another, a detector which detects that conversion of the transmission-source ID is made by comparing the transmission-source ID included in the header areas to the transmission-source ID included in the data areas, and a notification circuit to notify the transmission-source ID included in the header areas, as addresses for telephone conversations, to a plurality of communication terminals to be connection objects, when the detector detected that the conversion of the transmission-source ID is made.

### CROSS-REFERENCE TO RELATED APPLICATIONS

This application is based upon and claims the benefit of priority from prior Japanese Patent Applications No. 2005-137387, filed May 10, 2005, the entire contents of which are incorporated herein by reference.

### BACKGROUND OF THE INVENTION

1. Field of the Invention

One embodiment of the invention relates to a communication method and communication system for making telephone conversation between telephone terminals via an Internet Protocol (IP) network such as an IP telephone system.

2. Description of the Related Art

In recent years, IP telephone networks, namely a network telephone system adapted for real-time transmission and reception while handling images or voice as packet data in a bi-directional manner via a packet network, has been prevailingly popular. For IP telephone systems, a plurality of IP telephone terminals are connected to a private network such as a local area network (LAN), and the private network is connected to a public network or a global network such as the Internet via a router device. The router device makes address conversion, thereby enabling multimedia information communication between the multiple IP telephone terminals over the global network. In this case, the plurality of IP telephone terminals connected to the private network and the global network are handled as extension terminals of an exchange apparatus.

The above-described system incorporates a Network Address Translation (NAT) function in the router device. The NAT function is provided as a function for employing one IP address which has been allocated in advance for connection, thereby converting a private address into a global address to transmit the converted address as a transmission source IP address, followed by converting a global address of an IP address which is an address to be supplied in reception into a private address. Such an NAT function is described in an Request For Comments (RFC) 1631, and it is disclosed by, for example, Japanese Patent Application Publication (KOKAI) No. 2003-289318, Japanese Patent Application Publication (KOKAI) No. 2002-368773, and Japanese Patent Application Publication (KOKAI) No. 2003-324482.

In the above-described system, during transmission of a voice packet, an IP address and a port number included with a header area of an User Datagram Protocol (UDP) packet are converted by a router device. However, an IP address and a port number included in a data area of the UDP packet are not converted, making it impossible to correctly specify a destination, when a terminal which has received the UDP packet intends to return voice data, based on the transmission of the UDP packet by using the IP address and the port number included in the data area. Therefore, making it possible to connect an IP telephone terminal as extension of a main device, but making it substantially impossible to communicate voice data.

In order to solve this problem, development of a Virtual Private Network (VPN), an Application Level Gateway (ALG), a Simple Traversal of UDP Through NAT (STUN) protocol and the like is proposed.

However, in all of these schemes, any software which may convert an IP address and a port number included in a data area of the UDP packet, needs to be packaged for an IP telephone terminal or a router device, and therefore, the existing terminals and routers cannot be uniformly utilized as they are, forcing a user to expose a burden on cost efficiency or scheduling.

### BRIEF SUMMARY OF THE INVENTION

Therefore, it is an object of the present invention to provide a communication system capable of reliably making communication via a packet communication network without adding a function to a connection device for making connection between mutually different packet communication networks or a terminal connected to the packet communication networks; an exchange apparatus for use in the communication system; and a communication method for use in the communication system.

According to an aspect of the present invention, there is provided a communication system, comprising: a first communication terminal coupled to a first communication network having a communication channel used for a transmission of a communication packet including a header area and a data area; a second communication terminal coupled to a second communication network that is different form the first communication network; a connection apparatus coupling the first communication network and the second communication network; and an exchange apparatus coupled to at least one of the first communication network and the second communication network, the exchange apparatus in communication with the first communication terminal and the second communication terminal, wherein the exchange apparatus includes: a memory to store a transmission-source address information and a port number information included in the header area of the communication packet received from the first communication terminal or the second communication terminal; and means for notifying transmission-source address information and a port number information stored in the memory, as an address for a telephone conversation, to the first or the second communication terminal.

According to another aspect of the present invention, there is provided an exchange apparatus for use in a communication system, comprising a first communication terminal coupled to a first communication network having a communication channel used for a transmission of a communication packet including a header area and a data area; a second communication terminal coupled to a second communication network that is different form the first communication network; a connection apparatus coupling the first communication network and the second communication network; and an exchange apparatus coupled to at least one of the first communication network and the second communication network, the exchange apparatus in communication with the first communication terminal and the second communication terminal, the exchange apparatus further comprising: a memory to store a transmission-source address information and a port number information included in the header area of the communication packet received from the first communication terminal or the second communication terminal; and means for notifying transmission-source address information and a port number information stored in the memory, as an address for a telephone conversation, to the first or the second communication terminal.

According to yet another aspect of the present invention, there is provided a communication method for use in a communication system, comprising a first communication terminal coupled to a first communication network having a communication channel used for a transmission of a communication packet including a header area and a data area; a second communication terminal coupled to a second communication network; a connection apparatus coupling the first communication network and the second communication network; and an exchange apparatus in communication with the first communication terminal and the second communication terminal, comprising: storing, by the exchange apparatus, a transmission-source address information and a port number information included in the header area of the communication packet received from the first communication terminal or the second communication terminal, and making a communication between the first and the second terminals by notifying the transmission-source address information and the port number information stored by the exchange apparatus, as an address for a telephone conversation, to the first or the second communication terminal.

According to yet another aspect of the present invention, there is provided an exchange apparatus comprising an exchange control function to establish communications among communication terminals connected to a communication network used for transmissions of communication packets including header areas and data areas, respectively, the exchange apparatus further comprising: an acquisition circuit to acquire transmission-source ID included in the header areas and transmission-source ID included in the data areas of the communication packets received from each of a plurality of communication terminals to be connection objects when communication terminals are connected with one another; a detector which detects that conversion of the transmission-source ID is made by comparing the transmission-source ID included in the header areas to the transmission-source ID included in the data areas; and a notification circuit to notify the transmission-source ID included in the header areas, as addresses for telephone conversations, to a plurality of communication terminals to be connection objects, when the detector detected that the conversion of the transmission-source ID is made.

According to yet another aspect of the present invention, there is provided a communication system which comprises a plurality of communication terminals connectable to a communication network used for transmissions of communication packets including header areas and data areas, respectively, and an exchange apparatus coupled to the communication network and provided with an exchange control function to establish communications among the plurality of the communication terminals, in which The exchange apparatus comprises: an acquisition circuit to acquire transmission-source ID included in the header areas and transmission-source ID included in the data areas of the communication packets received from each of a plurality of communication terminals to be connection objects when communication terminals are connected with one another; a detector which detects that conversion of the transmission-source ID is made by comparing the transmission-source ID included in the header areas to the transmission-source ID included in the data areas; and a notification circuit to notify the transmission-source ID included in the header areas, as addresses for telephone conversations, to a plurality of communication terminals to be connection objects, when the detector detected that the conversion of the transmission-source ID is made.

According to yet another aspect of the present invention, there is provided a communication method for use in a communication system, comprising a plurality of communication terminals connectable to a communication network used for transmissions of communication packets including header areas and data areas, respectively, and an exchange apparatus coupled to the communication network and provided with an exchange control function to establish communications among the plurality of the communication terminals, the method comprising: acquiring transmission-source ID included in the header areas and transmission-source ID included in the data areas of the communication packets received from each of a plurality of communication terminals to be connection objects when communication terminals are connected with one another; detecting that conversion of the transmission-source ID is made by comparing the transmission-source ID included in the header areas to the transmission-source identification information included in the data areas; and notifying the transmission-source ID included in the header areas, as addresses for telephone conversations, to a plurality of communication terminals to be connection objects, when it is detected that the conversion of the transmission-source ID is made.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exemplary view showing a communication system according to a first embodiment of the present invention;

FIG. 2 is a block diagram showing an exemplary functional configuration of an exchange apparatus in the first embodiment;

FIG. 3 is an exemplary view showing a control channel route and a voice channel route, and a negotiation sequence between IP telephone terminals when making a telephone conversation in the first embodiment;

FIG. 4 is an exemplary diagram showing the negotiation sequence between IP telephone terminals when making the telephone conversation in the first embodiment;

FIG. 5 is a flow chart showing an exemplary processing operation of the exchange apparatus in the first embodiment;

FIG. 6 is an exemplary view showing a control channel route and a voice channel route, and a negotiation sequence between telephone terminals when making a telephone conversation in a second embodiment according to the present invention;

FIG. 7 is an exemplary diagram showing the negotiation sequence between IP telephone terminals when making the telephone conversation in the second embodiment;

FIG. 8 is an exemplary view showing a control channel route and a voice channel route, and a negotiation sequence between IP telephone terminals when making a telephone conversation in a third embodiment according to the present invention;

FIG. 9 is a block diagram showing an exemplary functional configuration of an exchange apparatus in the third embodiment;

FIG. 10 is an exemplary view showing an example of a storage content of an address table shown in FIG. 9;

FIG. 11 is an exemplary diagram showing the negotiation sequence between IP telephone terminals when registering an address in the third embodiment;

FIG. 12 is an exemplary view showing a structure of a registration message used in the third embodiment;

FIG. 13 is an exemplary diagram showing the negotiation sequence between IP telephone terminals when making the telephone conversation in the third embodiment; and

FIG. 14 is a flowchart showing an exemplary processing operation of the exchange apparatus in the third embodiment.

### DETAILED DESCRIPTION OF THE INVENTION

### First Embodiment

Various embodiments according to the present invention will be described hereinafter with reference to the accompanying drawings. In general, according to one embodiment of the invention, a communication method comprises receiving, in a first communication network, a packet from a terminal connected to a second communication network. The packet includes source address information therein. Then, a determination is made whether the source address information had been changed from an original address used in the second communication network to a changed address used in the first communication network. The changed address associated with the terminal is stored and a terminal connected to the first communication network is notified that the source address information includes the changed address. The terminal connected to the first communication network uses the source address information to communicate with the terminal connected to the second communication network.

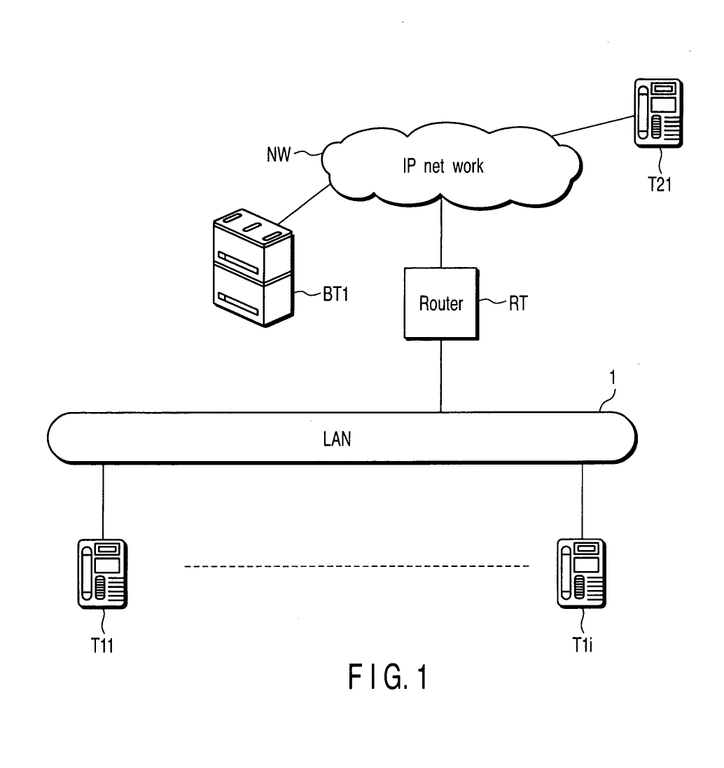

FIG. 1 shows a communication system to which a first embodiment of this invention is applied. The communication system includes a local area network (LAN) 1 operating as a private network. A plurality of telephone terminals T11 to T1i (i is a natural number) are connected to the LAN 1. The telephone terminals T11 to T1i are provided as IP telephone terminals, each of which comprises a telephone conversation processing function and a media information processing function. In addition, the LAN 1 has a plurality of media channels, and a control channel for transmitting a control signal for determining at least one of the media channels.

The communication system includes a router RT, as a connection device, coupled to the LAN 1. The router RT comprises a communication protocol and address conversion function between the LAN 1 and an IP network NW that is a global network.

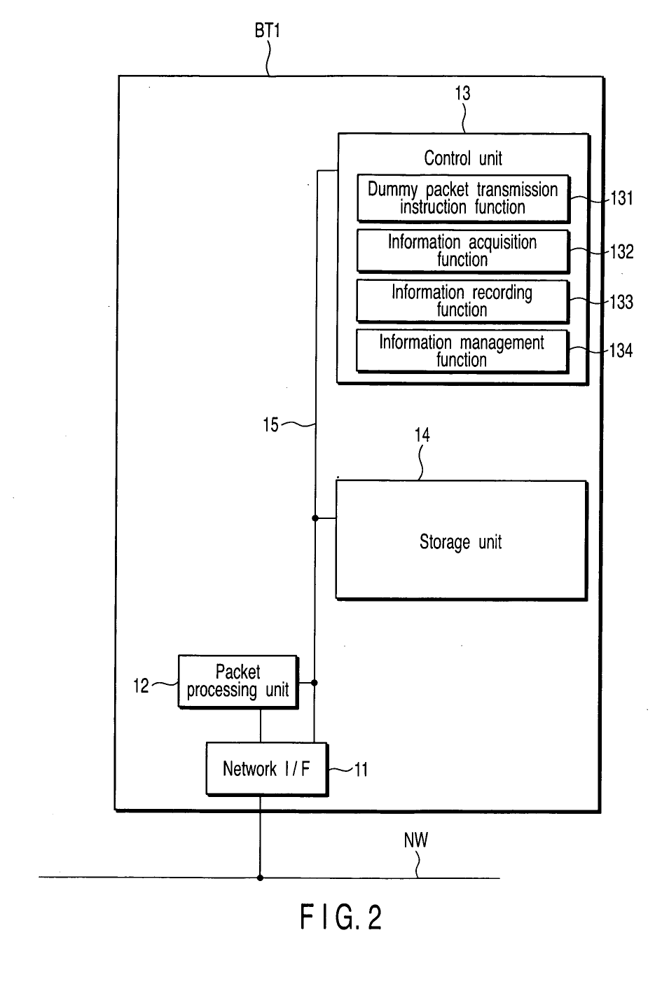

A telephone terminal T21 and an exchange apparatus BT1 that may be also referred as a main device, are connected to the IP network NW. The telephone terminal T21 is provided as an IP telephone terminal comprising a telephone conversation processing function and a media information processing function. The exchange apparatus BT1 has three basic functions. The first function is an exchange control function for the plurality of telephone terminals T11 to T1i, T21. The second function is an IP address allocation function for each of the telephone terminals T11 to T1i, T21. The third function is a function for managing an address allocated to each of the telephone terminals T11 to T1i, T21. In addition, the exchange apparatus BT1 has the following functions as set forth in FIG. 2.

FIG. 2 shows a functional configuration of the exchange apparatus BT1.

That is, the exchange apparatus BT1 comprises a network interface (hereinafter “I/F”) unit 11, a packet processing unit 12, a control unit 13, and a storage unit 14 that is a memory. The network I/F unit 11, the packet processing unit 12, the control unit 13, and the storage unit 14 are interconnected via The Interconnect 15 referred to as a “data highway”.

The IP network NW is coupled to the network I/F unit 11 as required. The network I/F unit 11 performs interface processing with the IP network NW that connects to the network I/F unit 11. The network I/F unit 11 also is adapted to receive control information associated with the above interface processing for transfer to the control unit 13 via the data highway 15.

The packet processing unit 12 processes a Real-time Transport Protocol (hereinafter “RTP”) packet upon receipt via the IP network NW.

The control unit 13 comprises a processor (CPU), a non-volatile memory (ROM), a volatile memory (RAM), and the like. Controls of each unit of the exchange apparatus BT1 is made by software processing.

The storage unit 14 stores routing information or the like required for connection control of the control unit 13.

The control unit 13, as shown in FIG. 2, comprises a dummy packet transmission instruction function 131, an information acquisition function 132, an information recording function 133, and an information management function 134. For example, when making a telephone conversation between the telephone terminal T11 and the telephone terminal T21, the dummy packet transmission instruction function 131 transmits an instruction signal so as to transmit a dummy RTP packet having inserted dummy data instead of voice data to each of the telephone terminals T11 and T21 via the control channel.

The information acquisition function 132 acquires an IP address which is a transmission source added to a data area of a control packet transmitted from each of the telephone terminals T11 and T21, and acquires port number information corresponding to a media channel added to a data area of the control packet, and acquires an IP address after conversion which is a transmission source added to a header area of the dummy RTP packet, and acquires port number information added to a header area of the dummy RTP packet.

The information recording function 133 compares the IP address and the port number information included in the header area of the RTP packet and the IP address and the port number information included in the data area of the same RTP packet, respectively. Then, the information recording function 133 determines, on the basis of the result of the comparison, whether or not the IP address and port number information on each of the acquired telephone terminals T11 and T21 has been address-converted by means of the router RT. In the case where the information in the header area has been converted or changed by the router RT, the IP address and port number information after conversion are recorded in the storage unit 14.

The information management function 134 manages the IP address and port number information after conversion and recordation in the storage unit 14, so as to be associated with the corresponding telephone terminals T11 and/or T21. Then, the telephone terminals T11 and T21 are notified of the IP address and port number information conversion so as to make a telephone conversation.

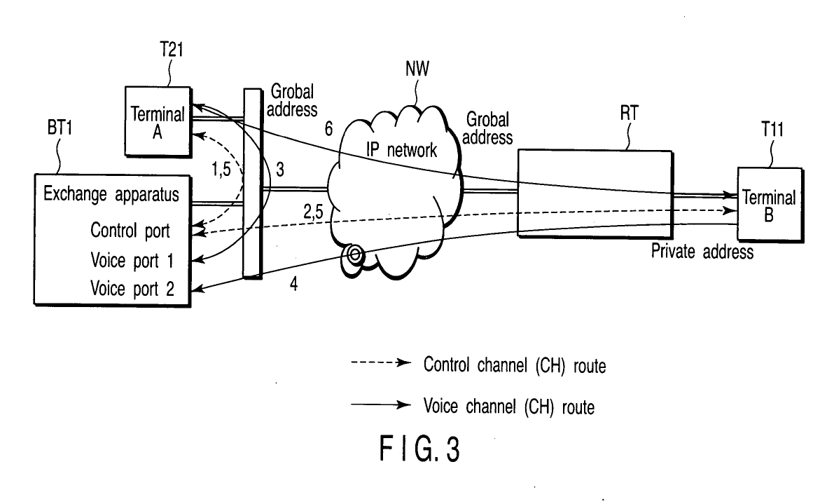

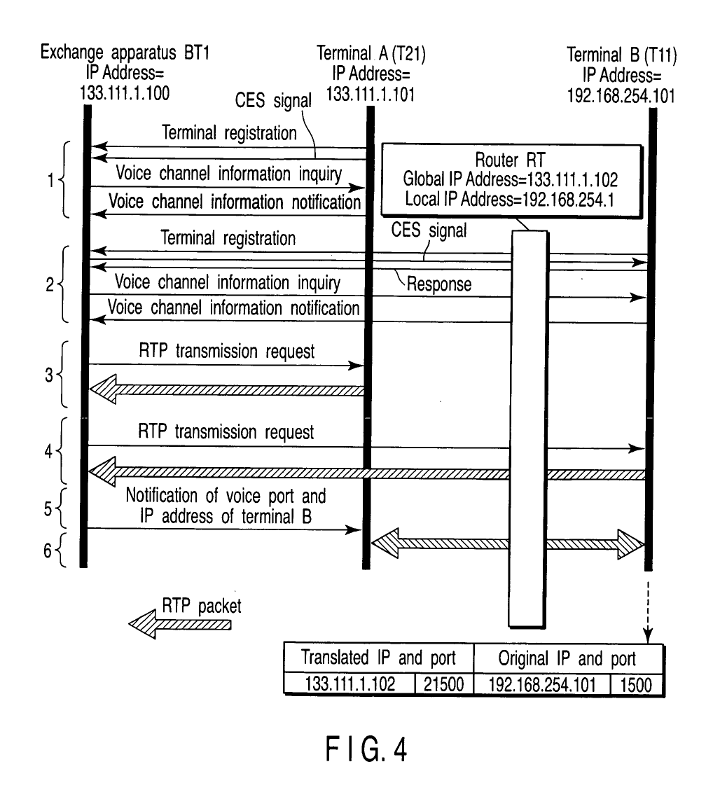

Now, an operation in the above construction will be described. FIGS. 3 and 4 show a negotiation sequence when making a telephone conversation between the telephone terminals T11 and T21.

For example, at first, a user of the telephone terminal T21 connected to the IP network NW makes a calling operation for the telephone terminal T11 in order to make a telephone conversion with the telephone terminal T11 connected to the LAN 1. Then, a communication establishment request signal (CER signal) is transmitted to the exchange apparatus BT1 from the telephone terminal T21 via the control channel on the IP network NW as represented by path 1.

The exchange apparatus BT1 having received the CER signal transmits the CER signal via the IP network NW, router RT, and LAN 1 to the telephone terminal T11 corresponding to the call arrival destination with reference to routing information as represented by path 2.

In the telephone terminal T11 having received the CER signal, a call is generated or a call arrival display is made, whereby generation of call arrival is broadcasted to the user. When the user makes a response operation to this call arrival broadcast, for example an operation of picking up a receiver, the telephone terminal T11 transmits a response signal to the router RT. The router RT having received the response signal transmits the response signal to the IP network NW.

At this time, the exchange apparatus BT makes inquiry of a voice channel to be used via the control channel for the telephone terminal T21, and makes inquiry of a voice channel to be used via the control channel to the telephone terminal T11 as represented by paths 3 and 4.

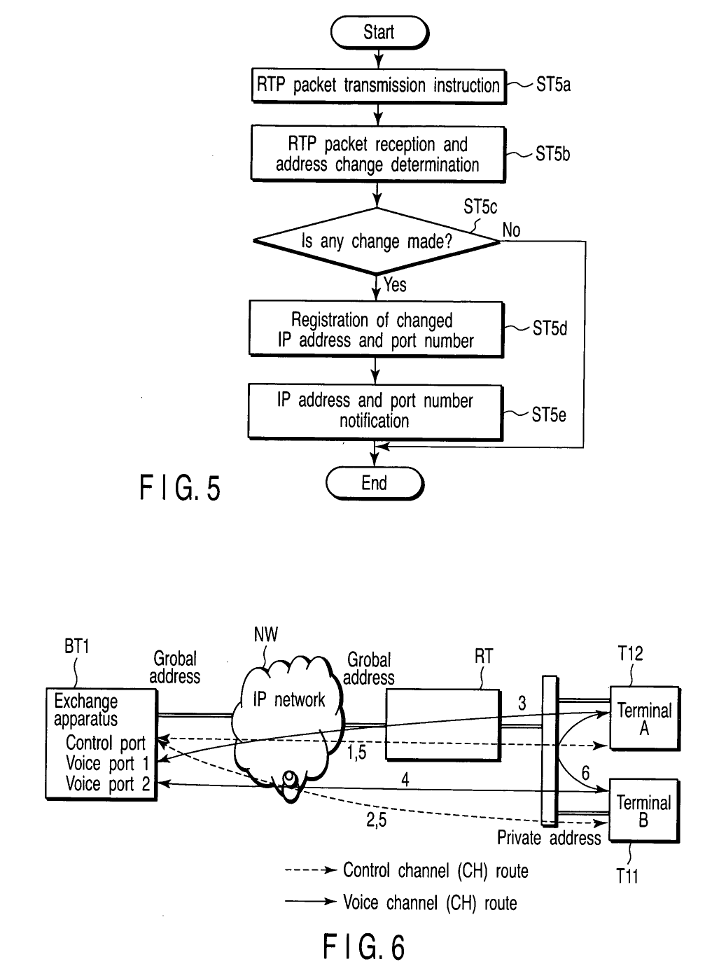

When the voice channel information to be used is notified from each of the telephone terminals T11 and T21 as represented by paths 5 and 6, the exchange apparatus BT1 executes control processing shown in FIG. 5.

In the exchange apparatus BT1, the control unit 13 supplies an instruction so as to make a call origination to a voice channel (“port 1”) having notified an RTP packet including dummy data instead of a voice signal to the telephone terminal T21 via the control channel (block ST5a). Similarly, the control unit 13 supplies an instruction so as to make a call origination to a voice channel (“port 2”) having notified an RTP packet to the telephone terminal T11 via the control channel.

Then, the control unit 13 having received the RTP packet from the telephone terminal T21 makes comparison between a call originator IP address included in the header area of the RTP packet and a call originator IP address included in the data area of the RTP packet (block ST5b). Based on this comparison result, the control unit 13 determines whether or not IP address conversion is made on a route (block ST5c). In the case of the telephone terminal T21, nothing is via the router RT, namely “No” in the block ST5c, and thus, the control unit 13 conducts ordinary packet processing.

On the other hand, the control unit 13 having received the RTP packet from the telephone terminal T11 makes comparison between a call originator IP address included in the header area of the RTP packet and a call originator IP address included in the data area of the RTP packet. In the case of the telephone terminal T11, information is via the router RT, namely “Yes” in the block ST5c, and thus, the control unit 13 registers the changed IP address and port number information into the storage unit 14 so as to be associated with the telephone terminal T11 (block St5d). Then, the registered IP address and port number information is notified to the telephone terminal T21 that is a telephone conversation party (block St5e).

Thus, telephone conversation is enabled between the telephone terminal T21 that is a call origination source and the telephone terminal T11 that is a call arrival destination.

As set forth in the above-described first embodiment, when a telephone conversation is made between the telephone terminal T11 and the telephone terminal T21, the exchange apparatus BT1 acquires the IP address and port number information coming from the telephone terminal T11 and to be added to the header area of the RTP packet after address conversion processing by the router RT so as to manage the acquired information in the storage unit 14 so as to be associated with the telephone terminal T11.

Therefore, the telephone terminal T11 corresponding to the IP address and port number information after address conversion by the router RT is recognized in the exchange apparatus BT1. Thus, the existing router and the existing telephone terminal may be utilized as they are without adding new functions to the router RT and the telephone terminals T11 to T1i and T21, respectively. Accordingly, the rise of the cost of the entire system may be restrained, and a telephone conversation between the telephone terminals T11 and T21 may be made.

In addition, according to the above-described first embodiment, only the IP address and port number information converted by the router RT are registered in the storage unit 14 of the exchange apparatus BT1. Thus, proper information acquisition processing and information management processing may be performed for each RTP packet without compressing a storage capacity of the storage unit 14.

Further, according to the first embodiment, the instruction signal is transmitted so as to generate the dummy RTP packet via the control channel to each of the telephone terminals T11 and T21. Whereby the IP address and port number information after address conversion by the router RT may be acquired prior to making a telephone conversation, and each of the telephone terminals T11 and T21 can immediately make shifts to telephone conversation processing at starting of a telephone conversation.

### Second Embodiment

FIG. 6 shows a communication system to which a second embodiment of this invention is applied. In FIG. 6, elements and communications paths as in the FIG. 1 are assigned similar reference numerals, and a detailed description thereof is omitted since it can be ascertained through analysis of the signal communications set forth in FIGS. 3 and 4.

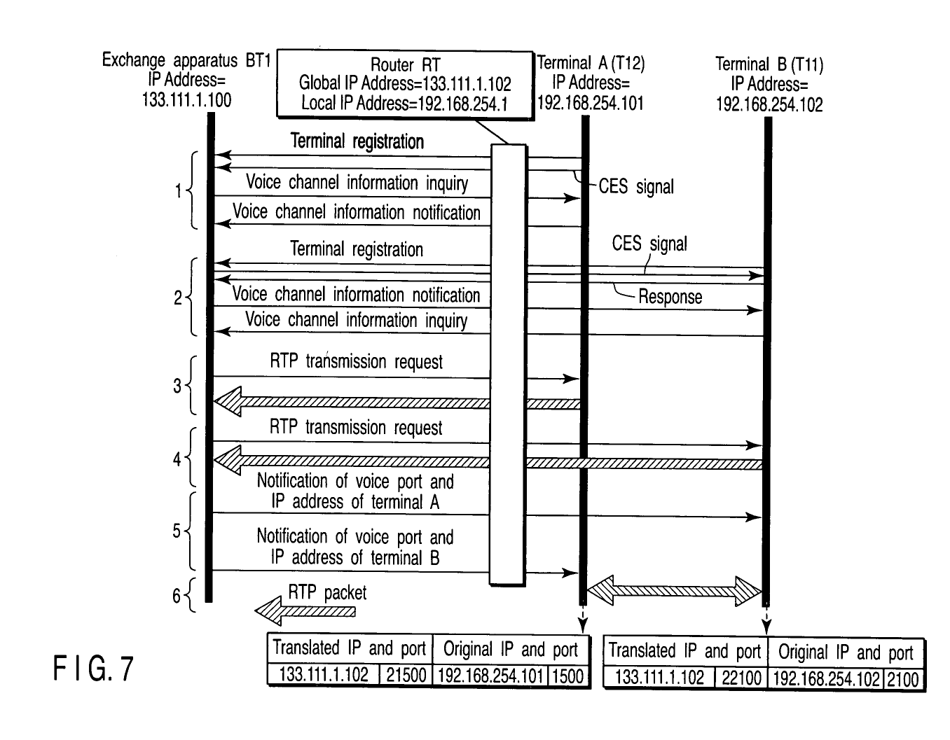

FIG. 7 shows a negotiation sequence when a telephone conversation is made between the telephone terminals T11 and T12.

For example, a user of the telephone terminal T12 connected to the LAN 1 makes a call origination operation for the telephone terminal T11 in order to make a telephone communication with the telephone terminal T11 connected to the LAN 1. In this case, a communication establishment request signal (CER signal) is transmitted from the telephone terminal T12 to the exchange apparatus BT1 via a control channel on the LAN 1 and the IP network NW.

The exchange apparatus BT1 having received the CER signal transmits a CER signal via the IP network NW, router RT, and LAN 1 to the telephone terminal T11 corresponding to a call arrival destination with referring to routing information.

In the telephone terminal T11 having received the CER signal, a call is generated or a call arrival display is made, whereby the generation of call arrival is broadcasted to the user. Then, when the user makes a response operation to this call arrival broadcast, for example an operation of picking up a receiver, the telephone terminal T11 transmits the response signal to the router RT. The router RT having received the response signal transmits the response signal to the IP network NW.

At this time, the exchange apparatus BT1 makes inquiry of a voice channel to be used via the control channel to the telephone terminal T12, and makes inquiry of a voice channel to be used via the control channel to the telephone terminal T11.

When voice channel information to be used is notified from each of the telephone terminals T11 and T12, the exchange apparatus BT1 supplies an instruction so as to make a call origination to a voice channel “port 1” having notified the RTP packet including dummy data instead of a voice signal to the telephone terminal T12 via the control channel. Similarly, the exchange apparatus BT1 supplies an instruction so as to make a call origination to a voice channel #port 2′ having notified the RTP packet to the telephone terminal T12 via the control channel.

Then, the exchange apparatus BT1 having received the RTP packet from the telephone terminal T12 compares a call originator IP address included in the header area of the RTP packet with a call originator IP address included in the data area of the RTP packet. Based on the comparison result, the control unit 13 determines whether or not address conversion is made on a route. In the case of the telephone terminal T12, as information is via the router RT, the exchange apparatus BT1 registers the changed IP address and port number information into the storage unit 14 so as to be associated with the telephone terminal T12.

On the other hand, the exchange apparatus BT1 having received the RTP packet from the telephone terminal T11 compares a call originator IP address included in the header area of the RTP packet with a call originator IP address included in the data area of the RTP packet. In the case of the telephone terminal T11 as well, information is via the router RT, and thus, the exchange apparatus BT1 registers the changed IP address and port number information into the storage unit 14 so as to be associated with the telephone terminal T11. The exchange apparatus BT1 then reads out the changed IP address correspond to the telephone terminal T11 and the changed IP address correspond to the telephone terminal T12 from the storage unit 14. In this case, since the IP addresses after conversion are the same with each other, the exchange apparatus BT1 comes to know that the information has transferred through the router RT.

Accordingly, the voice path between the telephone terminals T11 and T12 is closed in a network of the inside of the router RT, so that a method for an ordinary resolution of addresses is applied to resolve addresses for a voice path between the telephone terminals T11 and T12.

Hence, a telephone conversation is enabled between the telephone terminal T12 that is a call origination source and the telephone terminal T11 that is a call arrival destination.

As described above, even in the above-described second embodiment, advantageous effect similar to that of the first embodiment described above may be attained. In particular, for example, in the case where a plurality of companies or individuals shares one exchange apparatus BT on an IP network NW, there is no need for replacing such one exchange apparatus with a router or a telephone terminal having a new function for each company or individual. In this manner, a telephone conversation between the telephone terminals T11 and T12 may be made without forcing a cost efficiency burden on each company or individual.

### Third Embodiment

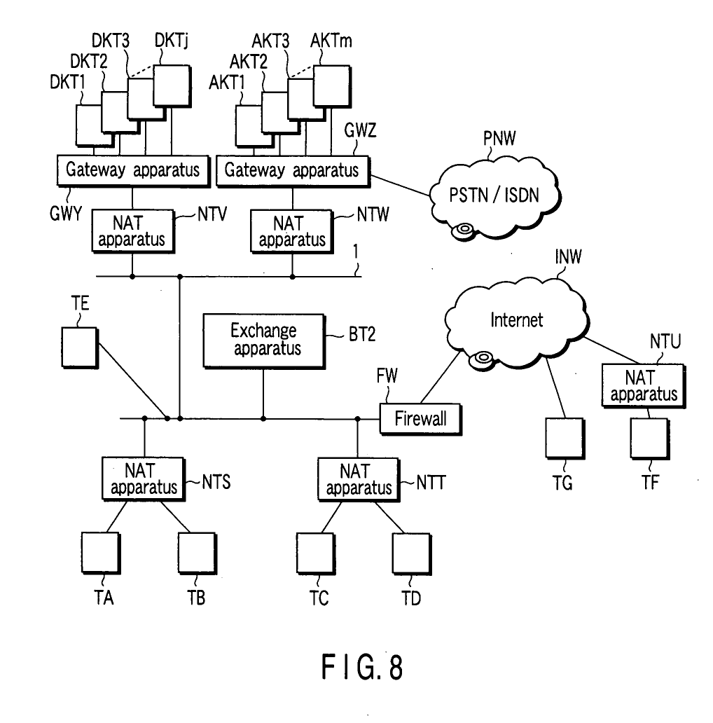

FIG. 8 shows a schematic view of a communication system regarding a third embodiment of the present invention. In FIG. 8, elements and communication paths as in the FIG. 1 are assigned similar reference numerals, and a detailed description thereof is eliminated since it can be ascertained through analysis of the signal communications set forth in FIGS. 3 and 4.

That is, the LAN 1 includes an exchange apparatus BT 2, an IP telephone terminal TE as a communication terminal, NAT apparatuses NTS, NTV and NTW, a firewall FW. The NAT apparatus NTS comprises an address conversion function among the LAN 1, IP telephone terminals TA and TB. The NAT apparatus NTT comprises a communication protocol and address conversion function among the LAN 1, IP telephone terminals TC and TD.

A gateway apparatus GWY is connected to the NAT apparatus NTV and a gateway apparatus GWZ is connected to the NAT apparatus NTW. A plurality of digital telephone sets DKT1 to DKTj (j is a natural number) are connected to the gateway apparatus GWY. A plurality of analog telephone sets AKT1 to AKTm (m is a natural number) and a public network PNW including a PSTN and an ISDN are connected to the gateway apparatus GWZ. The NAT apparatus NTV comprises an address conversion function among the LAN 1 and the digital telephone sets DKT1 to DKTj. The NAT apparatus NTW comprises an address conversion function among the LAN 1 and the analog telephone sets AKT1 to AKTm or between the LAN 1 and the public network PNW.

The firewall FW connects the LAN 1 to the Internet INW. An IP telephone terminal TG and an NAT apparatus NTU are connected to the Internet INW. The NAT apparatus NTU comprises an address conversion function between the Internet INW and an IP telephone terminal TF.

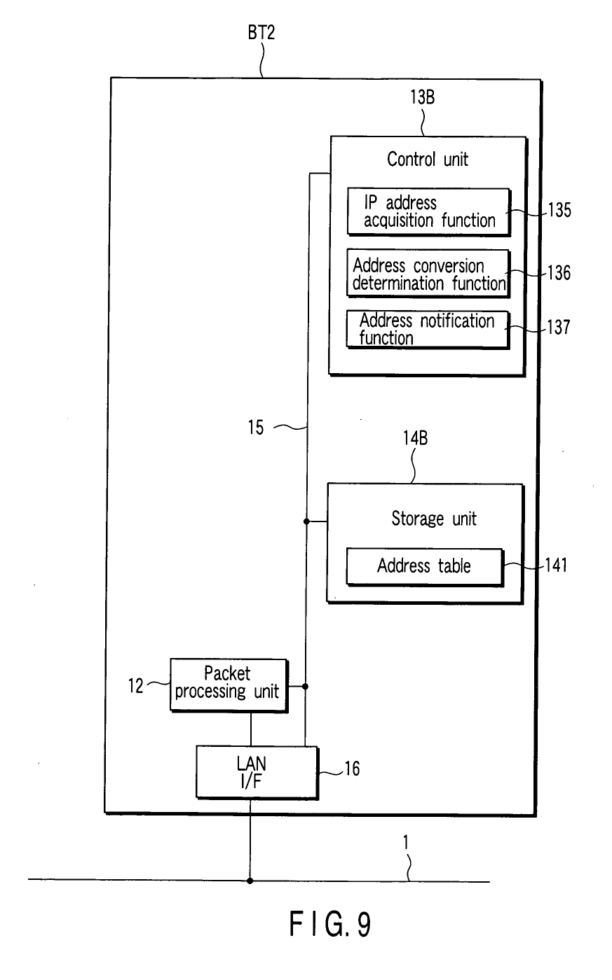

The exchange apparatus BT2 has the following functions as functions relating to the present invention. FIG. 9 shows an exemplary block diagram showing the configuration of the exchange apparatus BT2. In FIG. 9, elements and communications paths as in the FIG. 2 are assigned similar reference numerals, and a detailed description thereof is omitted since it can be ascertained through analysis of the signal communications set forth in FIGS. 3 and 4.

That is, the exchange apparatus BT2 has a LAN interface unit (LAN I/F unit) 16. The LAN 1 is coupled to the LAN I/F unit 16 as required. The LAN I/F unit 16 performs interface processing with the LAN 1 that connects to the LAN I/F unit 16. The LAN I/F unit 16 also is adapted to receive control information associated with the above interface processing for transfer to the control unit 13B via the data highway 15.

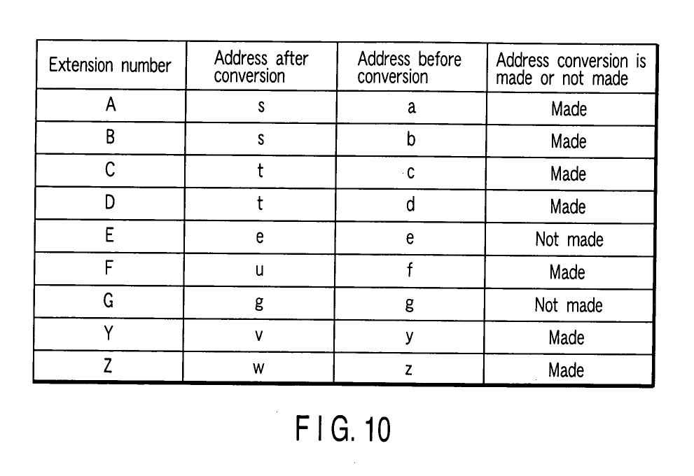

The control unit 13, as shown in FIG. 9, comprises an IP address acquisition function 135, an address conversion determination function 136, and an address notification function 137. A storage unit 14B is provided with an address table 141. The address table 141, as shown in FIG. 10, stores data indicating correspondence relations among extension numbers as identification information (ID) assigned to the IP telephone terminals TA to TG in advance, gateway numbers as ID assigned to gateway apparatuses GWY and GWZ in advance, addresses before conversion, addresses after conversion and the facts whether the address conversion is made or not made. Here, it is assumed that IP addresses of each IP telephone terminal TA to TG, gateway apparatus GWY and GWZ, NAT apparatuses NTS, NTT, NTV and NTW and the exchange apparatus BT2 are referred by small letters that have been turned from capital letters of the alphabets representing each of the foregoing terminals and apparatuses.

The IP address acquisition function 135 reads out, for example, information about the IP telephone terminals TA and TE from the address table 141 in the storage unit 14B when the user makes a telephone conversation between the IP telephone terminals TA and TE.

The address conversion determination function 136 determines whether the address conversion is made or not by, for example, passing through the NAT apparatus NTS on the basis of the information that has been read out by the IP address acquisition function 135.

The address notification function 137 notifies, for example, an IP address “s” of the address-converted IP telephone terminal TA to the IP telephone terminal TE, as an address for a telephone conversation when the address conversion determination function 136 determines that the address conversion is made, and also acquires a destination port number of an RTP packet corresponding to the IP telephone terminal TA to notify it to the IP telephone terminal TE and makes the IP telephone terminal TE return the RTP packet in accordance with the IP address “s” by receiving a UDP packet through the NAT apparatus NTS. Even when it is determined that the address conversion is made, when, for example, the IP telephone terminals TA and TB belonging to the NAT apparatus NTS belonging to the NAT apparatus NTS make a telephone conversation therebetween, a method for usually resolving addresses is applied to the IP telephone terminals TA and TB.

Now, operations in the foregoing configuration will be described.

Registration Procedures

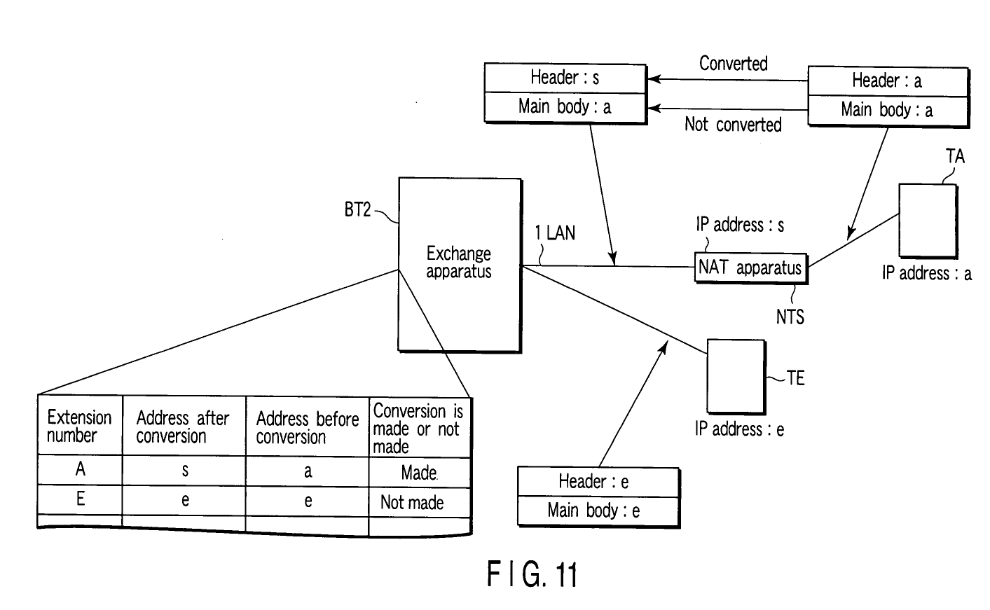

FIG. 11 is an exemplary diagram showing the negotiation sequence between, for example, IP telephone terminals TA and TE when making the telephone conversation in the third embodiment. Here, the negotiation is conducted by using a transmission control protocol/Internet protocol (TCP/IP).

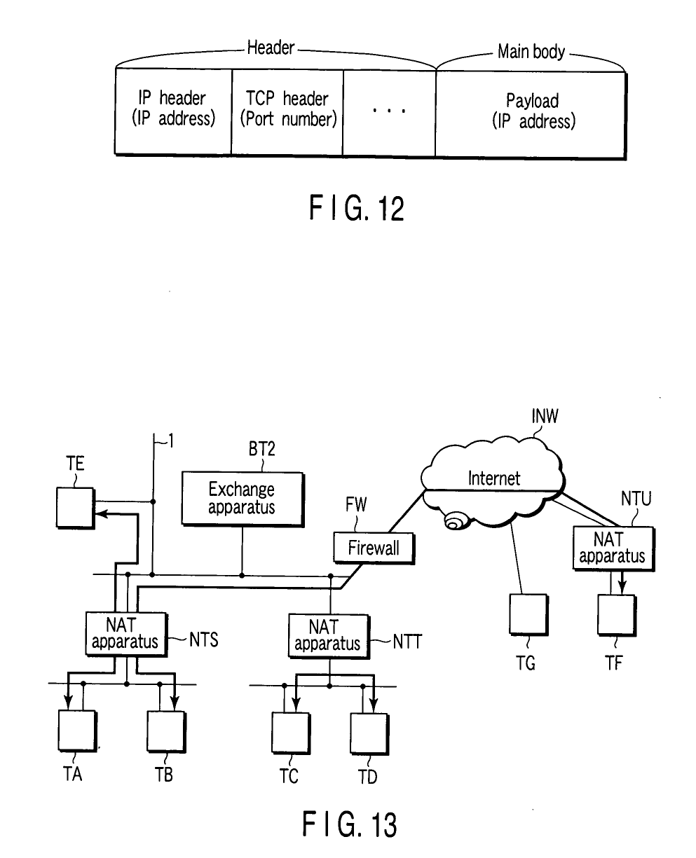

When being connected to the LAN 1, the IP telephone terminals TA and TE transmit registration messages shown in FIG. 12 to the exchange apparatus BT2. IP addresses “a” and “e” of each IP telephone terminal TA and TE are inserted into a main body (data area) of the registration message. The IP addresses “a” and “e” of each IP telephone terminal TA and TE also are inserted as call originator IP addresses to an IP header area of the registration message.

Here, the NAT apparatus NTS relays the registration message from the IP telephone terminal TA and converts the call originator IP address included in the IP header into the public address “s” effective in a public network, namely, the LAN 1 from the private address “a”. On the other hand, the registration message from the IP telephone terminal TE is not address-converted and arrived at the exchange apparatus BT2.

The exchange apparatus BT2 extracts an IP address of a registration originator from the main body of the received registration message and the IP address of the call originator from the IP header area and stores the extracted IP addresses in an address table 141 so as to be associated with identification information for the IP telephone terminals TA and TE. Here, the IP address extracted from the IP header area is treated as an address after conversion and it is assumed that address conversion is made on a registration route if the IP address before conversion and the address after conversion are different with each other.

(Telephone Conversation Between IP Telephone Terminal Under NAT Apparatus and IP Telephone Terminal not Under NAT Apparatus)

For example, as shown in FIG. 13, it is assumed that a user of the IP telephone terminal TE that is connected to the LAN 1 performs a calling operation to the IP telephone terminal TA in order to make telephone communication with a user of the IP telephone terminal TA. The IP telephone terminal TE then transmits a CER signal via the LAN 1 to the exchange apparatus BT2.

The exchange apparatus BT2 having received the CER signal transmits the CER signal to the IP telephone terminal TA corresponding to a call arrival destination via the LAN 1 and the NAT apparatus NTS with referring to the routing information.

In the IP telephone terminal TA having received the CER signal, a call is generated or a call arrival display is made, whereby the generation of call arrival is broadcasted to the user. Then, when the user makes a response operation to this call arrival broadcast, for example an operation of picking up a receiver, the IP telephone terminal TA transmits the response signal to the NAT apparatus NTS. The NAT apparatus NTS having received the response signal transmits the response signal to the exchange apparatus BT2.

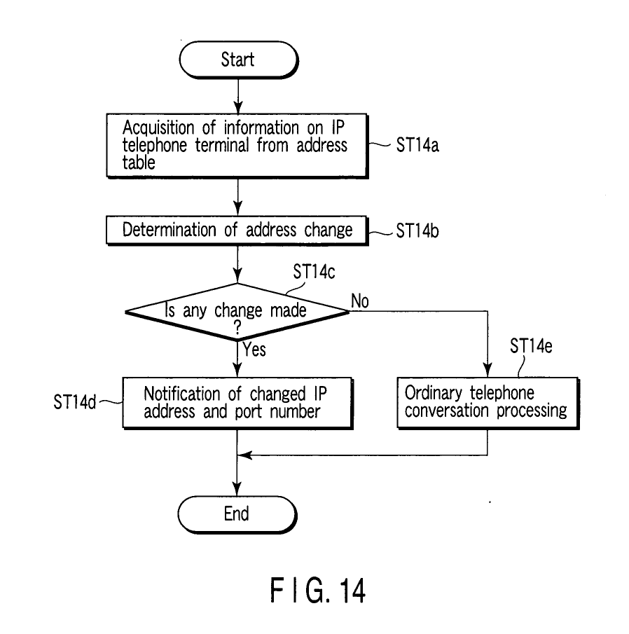

At this time, the exchange apparatus BT2 executes control processing as shown in FIG. 14.

In the exchange apparatus BT2, the control unit 13B reads out information about the IP telephone terminals TA and TE from the address table 141 (block ST14a) then determines whether or not the IP address conversion is made on the route, based on the foregoing information (block ST14b and block ST14c).

Since the NAT apparatus NTS is located on the route for the IP telephone terminal TA, the control unit 13B makes a shift to the processing in the block ST14d. In the block ST14d, the control unit 13B acquires port number information added to a header area of the dummy RTP packet transmitted from the IP telephone terminal TA, in other words, notifies the call originator IP address “s” inserted into the IP header area to the IP telephone terminal TE and also notifies the port number information to be used by the IP telephone terminal TA. The control unit 13B then makes the IP telephone terminal TE return the RTP packet, based on the call originator IP address “s” and the port number to be used by the IP telephone terminal TA.

Hence, a voice communication is enabled between the IP telephone terminal TS that is a call origination source and the IP telephone terminal TA that is a call arrival destination.

(Telephone Communication among IP Telephone Terminals Under Different NAT Apparatuses)

It is assumed that a user of the IP telephone terminal TB makes a calling operation to the IP telephone terminal TF so as to make a telephone communication with a user of the IP telephone terminal TF. Then, the exchange apparatus BT2 acquires port number information added to a header area of the dummy RTP packet transmitted from the IP telephone terminal TB, and acquires port number information added to a header area of the dummy RTP packet transmitted from the IP telephone terminal TF, reads out information relating to the IP telephone terminals TB and TF from the address table 141, notifies a call originator IP address “u” inserted into the IP header area to the IP telephone terminal TB and also notifies port number information to be used by the IP telephone terminal TF. After this, the exchange apparatus BT2 makes both IP telephone terminals TB and TF return RTP packets on the basis of the call originator IP addresses “u” and “s” and the port number information.

Hence, a voice communication is enabled between the IP telephone terminal TB that is a call origination source and the IP telephone terminal TF that is a call arrival destination.

(Telephone Communication among IP Telephone Terminals Under Identical NAT Apparatus)

It is assumed that a user of the IP telephone terminal TC makes a calling operation to the IP telephone terminal TD in order to make a telephone communication with a user of the IP telephone terminal TD. The exchange apparatus BT2 then reads out information relating to the IP telephone terminals TC and TD from the address table 141. In this case, since the IP addresses after conversion are the same with each other, the exchange apparatus BT2 comes to know that the information has transferred through the identical NAT apparatus NTT.

Accordingly, the voice path between the IP telephone terminals TC and TD is closed in a network of the inside of the NAT apparatus NTT, so that a method for an ordinary resolution of addresses is applied to resolve addresses for a voice path between the IP telephone terminals TC and TD (block ST14e).

As mentioned above, in the foregoing third embodiment, when making a telephone communication between the IP telephone terminals TA and TE, the exchange apparatus BT2 reads out information about the IP telephone terminals TA and TE, which is stored and managed in and by the address table 141, to determine whether conversion between the call originator IP address and the port number is made or not by using the read out information. And when the conversion between the call originator IP address and the port number is made, the exchange apparatus BT2 acquires the port number information to be used by the IP telephone terminal TA from the NAT apparatus NTS to notify the converted IP address, namely the port number information and port number information to be inserted in the IP header area to the IP telephone terminal TE.

Accordingly, the communication system according to the third embodiment of the present invention can utilize the existing IP telephone terminal as it is without having to add new functions to each IP telephone terminal TA and TE, respectively, and without considering the presence or absence of the NAT apparatus NTU by the sides of the users of each IP telephone terminal TA and TE. The third embodiment thereby can restrain the rise of the cost of the entire system and make the telephone conversation between the IP telephone terminals TA and TE.

Since the information stored and managed in and by the address table 141 is used, the communication system in the third embodiment can perform appropriate communication establishment processing in simple procedures without having to acquire the call originator IP address included in the IP header area of the RTP packet and the call originator IP address included in the main body from the IP telephone terminals TA and TE to be connection objects for each communication establishment.

And in the foregoing third embodiment, the communication system can perform optimum voice path establishment processing for each IP telephone terminal in a manner making the IP telephone terminal TA make an ordinary communication, and making the IP telephone terminal TE return the RTP packet by using the converted call originator IP address and the port number information.

Furthermore, in the foregoing third embodiment, when making a telephone conversation between the IP telephone terminal TC and the IP telephone terminal TD, the exchange apparatus BT2 determines whether the conversion between the call originator IP address and the port number is made or not and also determines whether or not the IP addresses after conversion are the same with each other. If the IP telephone terminals TC and TD are the same in addresses after conversion, the exchange BT2 then determines that the IP telephone terminals TC and TD are connected to the identical NAT apparatus NTT to execute the ordinary voice path establishment processing.

Accordingly, the communication system can perform appropriate voice path establishment processing, whereby reliability of communication establishment control can be further enhanced.

In the forgoing third embodiment, having described about an example to determine whether the conversion between the call originator IP address and the port number is made or not by using the information stored and managed in and by the address table 141, the communication system may acquire the IP address and port number information by making inquiry of the call originator IP address respectively inserted into the IP header area and the main body of the RTP packet to the IP telephone terminals TA and TE becoming to the connection targets at every generation of the connection requests without being provide with the address table 141.

According to above-mentioned third embodiment, the communication system has no need for including the address table 141 to store and manage the addresses before conversion and addresses after conversion for each IP telephone terminal. As a result, the communication system has an advantage to simplify the configuration of the exchange apparatus BT2 as well as to simplify the management of the IP telephone terminals.

### Other Embodiment

The present invention is not limited to the aforementioned embodiments. For example, although the aforementioned first and second embodiments have described an example of acquiring and registering IP address and port number information changed by a router during call origination of a telephone terminal, the IP address and port number information changed by the router may be acquired and registered, for example, during startup of the telephone terminal. By doing this, telephone conversation processing may be established with a shorter time period after determining a voice channel. In addition, another condition may be used.

Further, although the aforementioned first and second embodiments have described an example of connecting an exchange apparatus on an IP network, the exchange apparatus may be connected to a network other than the IP network.

And, although the foregoing third embodiment has described an example of registering an address before conversion and an address after conversion in an address table of an exchange apparatus, a port number before conversion and a port number after conversion also may be registered therein.

Moreover, although the above-mentioned each embodiment has described an example of making a voice communication, each of the embodiments also is applicable to a data communication.

Further, although the foregoing each embodiment has described an example of a telephone terminal, for example, a personal computer or a server having a telephone function may be used.

Furthermore, although each aforementioned embodiment has described a system with a LAN and an IP network having a plurality of media channels and control channels, each of the embodiments is applicable to a system with a LAN and an IP network only having a plurality of media channels.

In addition, various modifications of the invention may be put into effect without departing form the concept of the invention even in relation to a configuration and a type of a system, a configuration of an exchange apparatus, a kind of identification information and a communication packet, a kind of a control signal for use in negotiation, a procedure of the negotiation, processing of the communication packet or the like.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication system, comprising:
a first communication terminal coupled to a first communication network having a communication channel used for a transmission of a communication packet including a header area and a data area;
a second communication terminal coupled to a second communication network that is different form the first communication network;
a connection apparatus coupling the first communication network and the second communication network; and
an exchange apparatus coupled to at least one of the first communication network and the second communication network, the exchange apparatus in communication with the first communication terminal and the second communication terminal,
wherein the exchange apparatus includes: a memory to store a transmission-source address information and a port number information included in the header area of the communication packet received from the first communication terminal or the second communication terminal; and means for notifying transmission-source address information and a port number information stored in the memory, as an address for a telephone conversation, to the first or the second communication terminal.

2. The communication system according to claim 1, wherein the exchange apparatus stores the transmission-source address information and the port number information included in the header area of the communication packet into the memory, when the transmission-source address information included in the header area of the communication packet is different from the transmission-source address information included in the data area of the communication packet received from the first communication terminal or the second communication terminal.

3. The communication system according to claim 1, wherein the first communication terminal includes first address information for use the first communication network, the second communication terminal includes second address information for use the second communication network, and the connection apparatus converts the first address information into the second address information and converts the second address information into the first address information.

4. The communication system according to claim 3, wherein the first address information is a global IP address and the second address information is a private IP address used in a local area network.

5. An exchange apparatus for use in a communication system, comprising a first communication terminal coupled to a first communication network having a communication channel used for a transmission of a communication packet including a header area and a data area; a second communication terminal coupled to a second communication network that is different form the first communication network; a connection apparatus coupling the first communication network and the second communication network; and an exchange apparatus coupled to at least one of the first communication network and the second communication network, the exchange apparatus in communication with the first communication terminal and the second communication terminal, the exchange apparatus further comprising:
a memory to store a transmission-source address information and a port number information included in the header area of the communication packet received from the first communication terminal or the second communication terminal; and
means for notifying transmission-source address information and a port number information stored in the memory, as an address for a telephone conversation, to the first or the second communication terminal.

6. The exchange apparatus for use in the communication system according to claim 5, wherein the memory stores the transmission-source address information and the port number information included in the header area of the communication packet received from the first communication terminal or the second communication terminal when the transmission-source address information included in the header area of the communication packet is different from the transmission-source address information included in the data area of the communication packet.

7. A communication method for use in a communication system, comprising a first communication terminal coupled to a first communication network having a communication channel used for a transmission of a communication packet including a header area and a data area; a second communication terminal coupled to a second communication network; a connection apparatus coupling the first communication network and the second communication network; and an exchange apparatus in communication with the first communication terminal and the second communication terminal, comprising:
storing, by the exchange apparatus, a transmission-source address information and a port number information included in the header area of the communication packet received from the first communication terminal or the second communication terminal, and
making a communication between the first and the second terminals by notifying the transmission-source address information and the port number information stored by the exchange apparatus, as an address for a telephone conversation, to the first or the second communication terminal.

8. The communication method according to claim 7, wherein the exchange apparatus stores the transmission-source address information and the port number information included in the header area of the communication packet received from the first communication terminal or the second communication terminal, when the transmission-source address information included in the header area of the communication packet is different from the transmission-source address information included in the data area of the communication packet.

9. An exchange apparatus comprising an exchange control function to establish communications among communication terminals connected to a communication network used for transmissions of communication packets including header areas and data areas, respectively, the exchange apparatus further comprising:
an acquisition circuit to acquire transmission-source ID included in the header areas and transmission-source ID included in the data areas of the communication packets received from each of a plurality of communication terminals to be connection objects when communication terminals are connected with one another;
a detector which detects that conversion of the transmission-source ID is made by comparing the transmission-source ID included in the header areas to the transmission-source ID included in the data areas; and
a notification circuit to notify the transmission-source ID included in the header areas, as addresses for telephone conversations, to a plurality of communication terminals to be connection objects, when the detector detected that the conversion of the transmission-source ID is made.

10. The exchange apparatus according to claim 9, wherein the acquisition circuit transmits acquisition requests for the transmission-source ID included in the header areas and the data areas respectively, to a plurality of communication terminals to be connection objects; and acquires the transmission-source ID included in the header areas and the data areas transmitted from each communication terminals in response to transmissions of the acquisition requests, when connecting the communication terminals with one another.

11. The exchange apparatus according to claim 9, which further includes a memory to store transmission-source ID before conversion and transmission-source ID after conversion for each communication terminal, in which the acquisition circuit reads out the corresponding transmission-source ID before conversion as the transmission-source ID included in the data areas from the memory and reads out the transmission-source ID after conversion as the transmission-source ID included in the header areas, when connecting the communication terminals with one another.

12. The exchange apparatus according to claim 10, wherein the notification circuit notifies the transmission-source ID included in the header areas to the second communication terminal, as an address for a telephone conversation, when the acquisition circuit detects that the transmission-source ID has been converted with each other for the first communication terminal and detects that the transmission-source ID has not been converted with each other for the second communication terminal, among a plurality of communication terminals to be connection objects.

13. The exchange apparatus according to claim 12, wherein the notification circuit detects that the transmission-source ID has been converted with each other for the first and second communication terminals, respectively; and notifies the transmission-source ID included in the header areas to the first and second communication terminals, as addresses for telephone conversations, when the transmission-source ID included in the header areas after conversion is the same with each other.

14. A communication system which comprises a plurality of communication terminals connectable to a communication network used for transmissions of communication packets including header areas and data areas, respectively, and an exchange apparatus coupled to the communication network and provided with an exchange control function to establish communications among the plurality of the communication terminals, in which
the exchange apparatus comprises:
an acquisition circuit to acquire transmission-source ID included in the header areas and transmission-source ID included in the data areas of the communication packets received from each of a plurality of communication terminals to be connection objects when communication terminals are connected with one another;
a detector which detects that conversion of the transmission-source ID is made by comparing the transmission-source ID included in the header areas to the transmission-source ID included in the data areas; and
a notification circuit to notify the transmission-source ID included in the header areas, as addresses for telephone conversations, to a plurality of communication terminals to be connection objects, when the detector detected that the conversion of the transmission-source ID is made.

15. A communication method for use in a communication system, comprising a plurality of communication terminals connectable to a communication network used for transmissions of communication packets including header areas and data areas, respectively, and an exchange apparatus coupled to the communication network and provided with an exchange control function to establish communications among the plurality of the communication terminals, the method comprising:
acquiring transmission-source ID included in the header areas and transmission-source ID included in the data areas of the communication packets received from each of a plurality of communication terminals to be connection objects when communication terminals are connected with one another;
detecting that conversion of the transmission-source ID is made by comparing the transmission-source ID included in the header areas to the transmission-source ID included in the data areas; and
notifying the transmission-source ID included in the header areas, as addresses for telephone conversations, to a plurality of communication terminals to be connection objects, when it is detected that the conversion of the transmission-source ID is made.
